(19) United States
(12) Patent Application Publication
(10) Pub. No.: US 2010/0162082 A1
(43) Pub. Date: Jun. 24, 2010

(54) CONTROL DEVICE, STORAGE APPARATUS AND CONTROLLING METHOD

(75) Inventor: Keiichi Umezawa, Kahoku (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/640,188

(22) Filed: Dec. 17, 2009

(30) Foreign Application Priority Data
Dec. 19, 2008 (JP) 2008-323965

(51) Int. Cl. G06F 11/10; G06F 1/28

(52) U.S. Cl. 714/763; 713/340; 714/E11.032

(57) ABSTRACT

A control device operable under a power supplied from a main power source, the control apparatus includes a memory for storing data with an error detection code, the data being used for execution of processing, a judging section for judging whether an error in the data stored in the memory by the power from a sub power source is detected using the error detection code after the power from the main power source to the memory has been resumed. The control apparatus includes a processing control section for continuing execution of the processing using the data stored in the memory if it has been judged that no error in the data stored in the memory is detected by the judging section, and executing a recovery processing if it has been judged that an error in the data stored in the memory is detected.

### CROSS-REFERENCE TO RELATED APPLICATION

This application is based upon and claims the benefit of priority of the prior Japanese Patent Application No. 2008-323965, filed on Dec. 19, 2008, the entire contents of which are incorporated herein by reference.

### FIELD

The embodiments discussed herein are related to a control device, a storage apparatus and a controlling method.

### BACKGROUND

In some cases, a controller that controls the operation of an RAID (Redundant Arrays of Inexpensive Disks) apparatus operates to protect data stored in a memory by using a backup power source such as a battery and to hold information indicating that the protected data is present in a nonvolatile memory in order to prevent data stored in a volatile memory (hereinafter, simply referred to as a “memory”) from being lost to result in failure of operation due to stop and sudden disconnection of a power source (for example, an AC power source).

FIG. 12 is a diagram illustrating a configuration of a controller 610 of an RAID apparatus which is powered from a battery 615 upon occurrence of service interruption. As illustrated in FIG. 12, the controller 610 includes a control section 612 (for example, a CPU), a memory 613, a nonvolatile memory 614 (a nonvolatile area) and a battery 615. Service interruption may sometimes occur while the control section 612 is executing input-output processing using the memory 613 under the instruction from an upper apparatus (not illustrated). In the above mentioned case, the memory 613 is powered from a backup power source (the battery 615) in order to protect data which is being subjected to the input-output processing and the control section 612 operates to hold, in the nonvolatile memory 614, information indicating that data which is being subjected to the input-output processing is present in the memory before the power from the power source is stopped. Owing to the above mentioned operations, it is found that there exists the data which has been subjected to processing using the control section in the memory 613 before the power from the power source is stopped, so that the reliability of the data stored in the memory is guaranteed. Then, in the case that the information which has been stored in the nonvolatile memory 614 is referred to and the referred information indicates that data is present in the memory 613 after the service has been resumed from the interrupted state, the controller 610 operates to continue execution of processing utilizing the data which had been stored in the memory 613 immediately before the service interruption occurs.

In addition, in a certain RAID apparatus, controllers are redundantly installed in order to increase the reliability of data concerned. For example, in an RAID apparatus illustrated in FIG. 13, a dual controller constituted by two controllers is installed and both the controllers 610 and 630 of the dual controller (hereinafter, referred to as controllers of dual configuration) operate in synchronization with each other to store data of the same contents in magnetic disk apparatus.

In the RAID apparatus as illustrated in FIG. 13, it sometimes occurs that powering from a power source to both the controllers 610 and 630 of dual configuration is simultaneously stopped. Powering to both the controllers is stopped, for example, when service interruption has occurred. In the above mentioned case, when both the controllers have sensed occurrence of abnormality due to service interruption, control sections 612 and 632 of the respective controllers 610 and 630 operate to hold information indicating that data is present in memories 613 and 633 respectively in nonvolatile memories 614 and 634. Then, after the service has been resumed from the interrupted state, both the controllers 610 and 630 operate to refer to information stored in their nonvolatile memories 614 and 634. In the case that the referred information is information indicating that the data concerned is stored in the memories 613 and 633, the execution of the processing is continued using the data which has been stored in the nonvolatile memories 614 and 634 immediately before the service interruption occurs.

In addition, in the RAID apparatus as mentioned, it also sometimes occurs that powering from the power source to the controllers 610 and 630 of dual configuration is stopped at different times. For example, as illustrated in FIG. 15, when one controller 610 detects abnormality before the other controller 630 detects it, the control section 612 operates to hold information indicating that the data concerned is present in the memory 613 in the nonvolatile memory 614 and to notify the controller 630 that abnormality has been detected (operation (1)). Then, the controller 630 stops synchronous operation with the controller 610 (operation (2)) and operates to store information indicating that the data stored in the memory 613 of the controller 610 is not the latest in the nonvolatile memory 614 of the controller 610 (operation (3)).

Then, the controller 630 detects the abnormality and operates to hold information indicating that the data is present in the memory 633 in the nonvolatile memory 634. Then, when the power source is turned on again, the controller 610 refers to the information stored in the nonvolatile memory 614. It is found that the data stored in the memory 613 is not the latest in accordance with the referred information and hence the data is deleted. On the other hand, the controller 630 refers to the information stored in the nonvolatile memory 634. However, since information indicating that the data stored in the memory 633 is not included in the referred information, the controller 630 operates to continue execution of the processing using the data which has been stored in the memory 633 immediately before occurrence of the abnormality.

There is proposed a technique that utilizes data stored in a memory by using a nonvolatile memory in the case that powering from a power source to a controller of an RAID apparatus has been temporarily stopped and then resumed. This technique has such a problem that when abnormality occurs in the nonvolatile memory, reading out of information about the data stored in the memory stored in the nonvolatile memory is not allowed and hence the data stored in the memory may not be effectively utilized.

That is, when service interruption occurs, the controller of the RAID apparatus operates to hold, in the nonvolatile memory, information indicating that data on which input-output processing has been performed immediately before occurrence of the service interruption is stored in the memory. However, when it becomes difficult to read out the information concerned from the nonvolatile memory for some reasons, it may become impossible to decide whether there exists data in the memory. As a result, the controller has difficulty in judging whether the data in the memory is reliable even after the service has been resumed from the interrupted state and hence also has difficulty in utilizing the data in the memory. The same thing also applies to the case in which such abnormality that powering to both the controllers of dual configuration is stopped has occurred.

### SUMMARY

According to an aspect of the embodiment, a control device operable under a power supplied from a main power source, the control apparatus includes a memory for storing data with an error detection code by being supplied the power from the main power source or a power from a sub power source, the data being used for execution of processing, a judging section for judging whether an error in the data held in the memory by being supplied the power from the sub power source is detected using the error detection code after the power from the main power source to the memory has been resumed, and a processing control section for continuing execution of the processing using the data stored in the memory if it has been judged that no error in the data stored in the memory is detected by the judging section, and executing a recovery processing if it has been judged that an error in the data stored in the memory is detected.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a general configuration of an RAID system according to an embodiment of the present technique.

FIG. 2 is a functional block diagram illustrating a configuration of a control section.

FIG. 3 is a flowchart illustrating processing performed by a control device.

FIG. 4 is a diagram illustrating an example of a general configuration of an RAID system according to an embodiment of the present technique.

FIG. 5 is a functional block diagram illustrating a configuration of a control section.

FIG. 6 is a flowchart illustrating processing performed by a control device.

FIG. 7 is a diagram illustrating a resuming operation performed on a control device in the case that an abnormal factor is service interruption.

FIG. 8 is a diagram illustrating a resuming operation performed on a control device in the case that the abnormal factor is abnormality other than service interruption.

FIG. 9 is a functional block diagram illustrating a configuration of a control section according to an embodiment of the present technique.

FIG. 10 is a flowchart illustrating processing performed by a control device.

FIG. 11 is a diagram illustrating an example of a resuming operation performed on a control device.

FIG. 12 is diagram illustrating an example of a configuration of a controller of an RAID apparatus in service interruption.

FIG. 13 is a diagram illustrating an example of a configuration of a dual controller of an RAID apparatus.

FIG. 14 is a diagram illustrating a resuming operation performed on controllers of an RAID apparatus when abnormality has occurred simultaneously in both the controllers.

FIG. 15 is a diagram illustrating a resuming operation performed on controllers of an RAID apparatus when abnormality has occurred in the controllers at different times.

### DESCRIPTION OF EMBODIMENTS

Next, preferred embodiments of a control device, a controlling method and a storage apparatus of the present technique will be described in detail with reference to the accompanying drawings. Incidentally, the present technique is not limited to the embodiments.

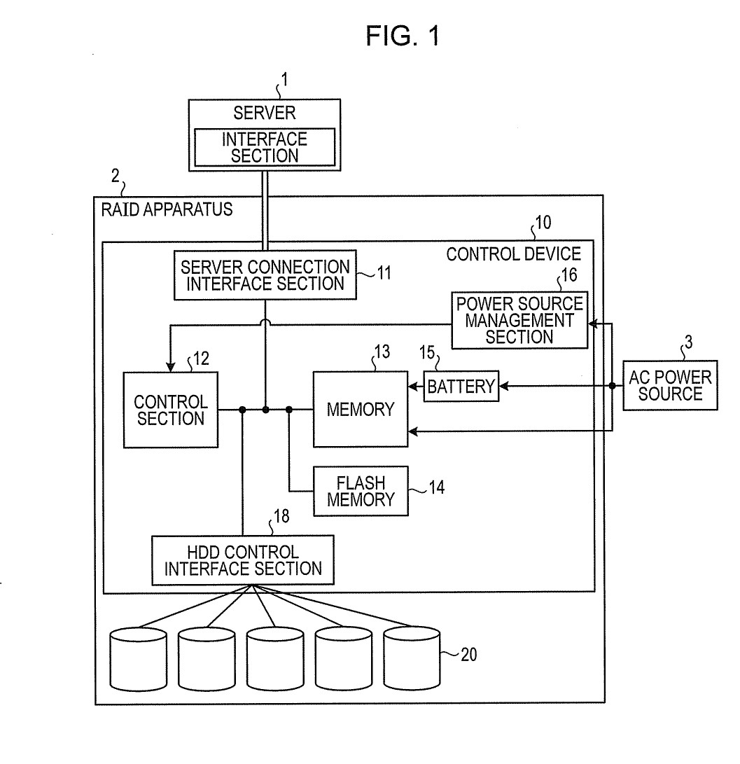

FIG. 1 is a diagram illustrating an example of a general configuration of an RAID system including an RAID apparatus as an example of a storage apparatus according to a first embodiment of the present technique. As illustrated in FIG. 1, an RAID apparatus 2 is connected to a server 1 as an upper apparatus (a host computer) of the RAID apparatus and includes a control device 10 and a storage device 20. The control device 10 includes a server connection interface section 11, a control section 12, a memory 13, a flash memory 14, a battery 15 and a power source management section 16. The control device 10 operates to execute input-output processing that acquires an input-output request from the server 1 and inputs data into and outputs data from the storage device 20 in accordance with the acquired input-output request.

The server connection interface section 11 is an interface through which the server 1 and the RAID apparatus 2 exchange data and includes, for example, a port.

When abnormality which may be a factor to stop powering from an AC power source 3 to the memory 13 is sensed while processing is being executed in accordance with the input-output request from the server 1, the control section 12 operates to hold information indicating that data is stored in the memory 13 in the flash memory 14. Then, the control section 12 operates to shut down the own device although not illustrated in the drawing. In the example illustrated in FIG. 1, the abnormality which may be the factor to stop powering from the AC power source 3 to the memory 13 means abnormality, for example, such as service interruption, abnormality in powering other than the service interruption and abnormality such as a malfunction of a functional section (such as a CPU (Central Processing Unit)) installed in the control device 10. Thus, hereinafter, the abnormality will be abbreviated as “memory powering abnormality”. Information indicating that data is stored in the memory 13 is information used to notify the control section 12 which is resumed after shut-down that the data which has been an object of input-output processing immediately before the “memory powering abnormality” is detected is present in the memory 13. If this information is stored in the flash memory 14, the control section 12 will operate to continue execution of the input-output processing using the data which has been the object of input-output processing immediately before the “memory powering abnormality” is detected after the control section is shut-down and resumed.

The control section 12 operates to judge whether the data which has been the object of input-output processing is stored in the memory 13, when powering from the AC power source 3 to the memory 13 has been resumed after temporal stop. Specifically, the control section 12 operates to judge whether the information indicating that the data concerned is present in the memory 13 is stored in the flash memory 14. In the above mentioned situation, if it is sensed that the flash memory 14 is abnormal, the information stored in the flash memory 14 will not be used to judge whether the data which has been the object of input-output processing is stored in the memory 13, so that the control section 12 operates to read out data from an arbitrary address of the memory 13. For example, the control section 12 operates to read out an information data segment corresponding to a unit length of information data to which an error detection code is added and an error detection code segment corresponding to the length of the error detection code added to the information data segment concerned from the arbitrary address of the memory 13. Then, the control section 12 operates to perform error detection on the read-out information data segment using the error detection code. When a result that an error in the data is not detected is obtained, the control section 12 finds that the error detection code is added to the data and hence also finds that the data which has been the object of input-output processing immediately before powering from the AC power source 3 to the memory 13 is stopped is stored in the memory 13, so that the control section 12 operates to continue execution of the input-output processing using the data stored in the memory 13. On the other hand, when a result that the error in the data is detected is obtained, there is a possibility that the data in the memory 13 is meaningless data with no addition of the error detection code and hence the control section 12 operates to initialize the memory 13. Incidentally, as an example of the error detection code, for example, an ECC (Error Correcting Code) is given, however the code is not limited to the ECC.

The memory 13 is a volatile memory that will lose data stored therein when no power is supplied from the AC power source 3 or the battery 15 and includes, for example, a DDR-SDRAM (Double data rate Synchronous Dynamic Random Access Memory) with ECC module. When powering from the AC power source is stopped due to occurrence of the “memory powering abnormality” while the input-output processing is being executed by the control section 12, the memory 13 is powered from the battery 15 before shut-down to hold the data used for execution of the input-output processing in order to prevent the input-output processing from being erroneously executed.

The flash memory 14 is a nonvolatile memory that will not lose data stored therein even with no power. The data used for execution of the input-output processing is not stored in the flash memory 14 as a backup data when the memory powering abnormality has been occurred.

The battery 15 is a sub power source to back up the main power source and supplies the power to the memory 13 in place of the AC power source when powering from the AC power source is stopped while the input-output processing is being executed.

The power source management section 16 usually monitors the voltage of the AC power source 3 to judge whether service interruption or another power source abnormality occurs, and, when the service interruption or another power source abnormality has been judged to occur, outputs a notification that the abnormality has occurred to the control section 12 together with the factor of the abnormality. Although, in the example illustrated in FIG. 1, the power source abnormality other than service interruption includes abnormality brought about by sudden disconnection due to abnormality in voltage, static electricity or other factors, it is not limited thereto.

A hard disk control interface section (hereinafter, referred to as an HDD control interface section) 18 is an interface that performs data exchange between the control device 10 and the storage device 20 and includes, for example, a port.

The storage device 20 is constituted by a plurality of hard disks and data is stored in each hard disk.

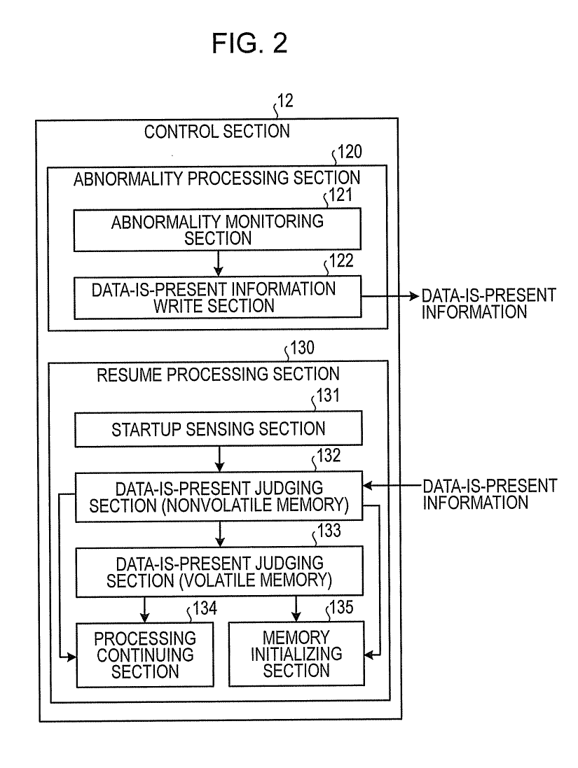

Next, FIG. 2 is a functional block diagram illustrating a configuration of the control section according to an embodiment 1. As illustrated in FIG. 2, the control section 12 has an abnormality processing section 120 and a resume processing section 130.

The abnormality processing section 120 executes abnormality processing such as processing of the “memory powering abnormality” and has an abnormality monitoring section 121 and a data-is-present information write section 122.

The abnormality monitoring section 121 monitors the notification “memory powering abnormality” output from the power source management section 16 and each functional section in the control device 10, and when the “memory powering abnormality” is sensed, notifies the data-is-present information write section 122 that the “memory powering abnormality” has been sensed. When information indicating that the “memory powering abnormality” has occurred is acquired from the power source management section 16 and each functional section in the control device 10 together with the factor of “memory powering abnormality”, the abnormality monitoring section 121 notifies the data-is-present information write section 122 that the “memory powering abnormality” has occurred.

When the abnormality monitoring section 121 notifies the data-is-present information write section 122 that the “memory powering abnormality” has occurred, since the data which has been the object of input-output processing is stored in the memory 13, the data-is-present information write section 122 stores information indicating that the data concerned is present in the memory 13 in the flash memory 14. As an alternative, since the data which has been the object of input-output processing is present in the memory 13, the data-is-present information write section 122 may write a specific code indicating that the data concerned is present in the memory 13 into the memory 13. The specific code may be a predetermined numeral or symbol.

The resume processing section 130 is configured to execute resume processing to be performed after the device has been shut down due to the occurrence of the “memory powering abnormality” and has a startup sensing section 131, a data-is-present judging section 132 in a nonvolatile memory, a data-is-present judging section 133 in a volatile memory, a processing control section 134 and a memory initializing section 135.

The startup sensing section 131 senses that the AC power source 3 has been turned on and then notifies the data-is-present judging section 132 in the nonvolatile memory that the AC power source 3 has been turned on.

The data-is-present judging section 132 in the nonvolatile memory judges whether the data which has been the object of input-output processing is present in the memory 13. Specifically, the data-is-present judging section 132 judges whether the information indicating that the data concerned is present in the memory 13 is stored in the flash memory 14. In the above mentioned case, when information indicating that the flash memory 14 is abnormal is sensed, the data-is-present judging section 132 in the nonvolatile memory is not allowed to decide whether the data which has been the object of input-output processing is present in the memory 13 and hence notifies the data-is-present judging section 133 in the volatile memory that the flash memory 14 is abnormal. In addition, when it has been judged that the information indicating that the data concerned is present in the memory 13 is stored in the flash memory 14, the data-is-present judging section 132 in the nonvolatile memory notifies the processing control section 134 that the data which has been the object of input-output processing is present in the memory 13. On the other hand, when it has been judged that the information indicating that the data concerned is present in the memory 13 is not stored in the flash memory 14, the data-is-present judging section 132 in the nonvolatile memory notifies the memory initializing section 135 that the data which has been the object of input-output processing is not present in the memory 13.

The data-is-present judging section 133 in the volatile memory judges whether the data which has been the object of input-output processing is present in the memory 13 when the flash memory 14 is abnormal. Specifically, when a notification that the flash memory 14 is abnormal is received from the data-is-present judging section 132, the data-is-present judging section 133 reads out the information data segment corresponding to the unit length of the information data to which the error detection code is added and the error detection code segment corresponding to the length of the error detection code which is added to the information data concerned from the arbitrary address of the memory 13. Then, the data-is-present judging section 133 performs error detection on the read out information data segment using the error detection code. In the above mentioned situation, in the case that a result that an error in the data is not detected has been obtained, the data-is-present judging section 133 in the volatile memory finds that the error detection code is added to the data in the memory 13 and also finds that the data which has been the object of input-output processing immediately before powering from the AC power source 3 to the memory 13 is stopped is stored in the memory 13, and hence notifies the processing control section 134 that the data which has been the object of input-output processing is present in the memory 13. On the other hand, in the case that a result that an error in the data is detected has been obtained, there is a possibility that the data in the memory 13 may be meaningless data to which the error detection code is not added, so that the data-is-present judging section 133 in the volatile memory notifies the memory initializing section 135 that the data which has been the object of input-output processing is not stored in the memory 13.

In the above mentioned situation, in the case that a specific code is stored in the memory 13 by the abnormal processing section 120, the data-is-present judging section 133 in the volatile memory may judge whether the specific code is stored in the memory 13 in order to more accurately confirm as to whether the data which has been the object of input-output processing is stored in the memory 13. In the above mentioned case, if the specific code is stored in the memory 131, the data-is-present judging section 133 in the volatile memory will find that the data which has been the object of input-output processing immediately before powering from the AC power source 3 to the memory 13 is stopped is stored in the memory 13 and hence will find that the data which has been the object of input-output processing is present in the memory 13. Incidentally, the data-is-present judging section 133 in the volatile memory may use one of the result obtained by reading out the data from the arbitrary address and the result obtained by reading out the specific code from the memory 13 or may use both of them in order to judge whether the data which has been the object of input-output processing is present in the memory 13.

When a notification that the data which has been the object of input-output processing is present in the memory 13 is received from the data-is-present judging section 132 or the data-is-present judging section 133, the processing control section 134 continues execution of the input-output processing using the data stored in the memory 13.

When a notification that the data which has been the object of input-output processing is not present in the memory 13 is received from the data-is-present judging section 132 or the data-is-present judging section 133, the memory initializing section 135 initializes the memory 13.

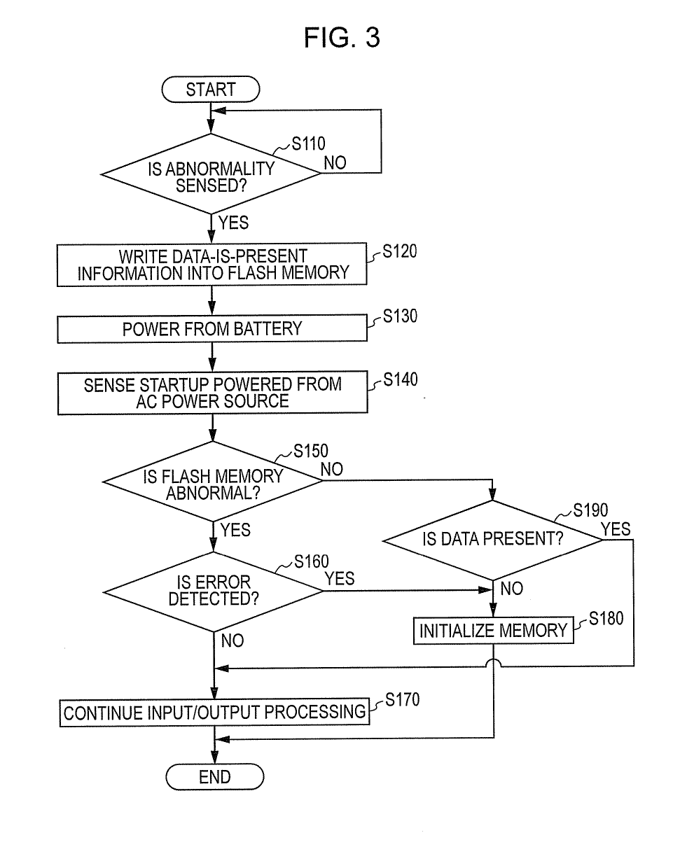

Next, the processing executed by the control device according to the embodiment 1 will be described with reference to FIG. 3. FIG. 3 is a diagram illustrating a flowchart of the processing executed by the control device according to the embodiment 1.

First, the abnormality monitoring section 121 of the abnormality processing section 120 monitors the notification “memory powering abnormality” output from the power source management section 16 and each functional section in the control device 10, and judges whether the “memory powering abnormality” has been sensed (S110). In the above mentioned situation, when the “memory powering abnormality” is not sensed (No, at S110), the abnormality monitoring section 121 repeats the same judging process until the “memory powering abnormality” is sensed.

On the other hand, when the “memory powering abnormality” is sensed (Yes at S110), the abnormality monitoring section 121 informs the data-is-present information write section 122 that the “memory powering abnormality” has occurred. Then, the data-is-present information write section 122 which has received the notification that the “memory powering abnormality” has occurred writes the information indicating that the data concerned is present in the memory 13 into the flash memory 14 (S120).

Then, the battery 15 starts powering to the memory 13 (S130). Then, the control device 10 is shut down and powering from the AC power source 3 to the memory 13 is stopped.

Then, when the control device 10 is again powered from the AC power source 3, the startup sensing section 131 senses that the AC power source 3 has been tuned on (S140) and informs the data-is-present judging section 132 in the nonvolatile memory that the AC power source 3 has been turned on.

The data-is-present judging section 132 which has received the notification that the AC power source 3 has been turned on judges whether the flash memory 14 is abnormal (S150). Specifically, the data-is-present judging section 132 in the nonvolatile memory judges whether reading is abnormal when the information indicating that the data concerned is present in the memory 13 is read out from the flash memory 14.

When it has been judged that the flash memory 14 is abnormal (Yes at S150), the data-is-present judging section 132 in the nonvolatile memory informs the data-is-present judging section 133 in the volatile memory that the flash memory 14 is abnormal.

The data-is-present judging section 133 which has received the notification that the flash memory 14 is abnormal from the data-is-present judging section 132 in the nonvolatile memory reads out data from an arbitrary address of the memory 13 and judges whether an error in the read-out data is detected (S160). Specifically, the data-is-present judging section 133 in the volatile memory reads out the information data segment corresponding to the unit length of the information data to which the error detection code is added and the error detection code segment corresponding to the length of the error detection code which is added to the information data segment concerned from the arbitrary address of the memory 13. Then, the data-is-present judging section 133 in the volatile memory performs error detection on the read-out information data segment using the error detection code to judge whether a result that the error in the data is not detected is obtained.

When it has been judged that the error in the data is not detected (No at S160), it is found that the error detection code is added to the data in the memory 13 and hence the data-is-present judging section 133 in the volatile memory informs the processing control section 134 that the data which has been the object of input-output processing is present in the memory 13. Then, the processing control section 134 continues execution of the input-output processing using the data stored in the memory 13 (S170).

On the other hand, when it has been judged that the error in the data is detected (Yes as S160), the data-is-present judging section in the volatile memory informs the initializing section 135 that the data which has been the object of input-output processing is not present in the memory 13 and hence the memory initializing section 135 initializes the memory 13 (S180). In addition, the processing control section 134 operates to notify the server 1 that the data in the memory 13 may be unrecovered because it has been judged that the error detection code is missing from the data stored in the memory. And then, the control section 12 operates to stop the RAID apparatus 2, as a recovery processing.

When it has been judged that the flash memory 14 is normal (No at S150), the data-is-present judging section 132 in the nonvolatile memory judges whether the information indicating that the data concerned is present in the memory 13 is stored in the flash memory 14 (S190).

When it has been judged that the information indicating that the data concerned is present in the memory 13 is stored in the flash memory 14 (Yes at S190), the data-is-present judging section 132 in the nonvolatile memory informs the processing control section 134 that the data which has been the object of input-output processing is present in the memory 13 and hence the processing control section 134 continues execution of the input-output processing using the data stored in the memory 13.

On the other hand, when it has been judged that the information indicating that the data concerned is present in the memory 13 is not stored in the flash memory 14 (No at S190), the data-is-present judging section 132 in the nonvolatile memory informs the memory initializing section 135 that the data which has been the object of input-output processing is not present in the memory 13 and hence the memory initializing section 135 initializes the memory 13. In addition, the processing control section 134 operates to notify the server 1 that the data in the memory 13 may be unrecovered, and the control section 12 operates to stop the RAID apparatus 2.

As described above, according to the present embodiment, the control device 10 operates to store in the memory 13 the data used for execution of the input-output processing concerned by being powered from the AC power source 3 while the input-output processing which has been instructed from the server 1 is being executed. Then, when powering from the AC power source 3 to the memory 13 has been stopped and then started again, the control device 10 operates to judge whether the error detection code is added to the data stored in the memory 13. Then, when it has been judged that the error detection code is added to the data stored in the memory 13 as a result of judgment, the control device 10 operates to continue execution of the input-output processing using the data stored in the memory 13.

When it has been found that the error detection code is added to the data stored in the memory 13 in the above mentioned manner, the control device 10 finds that the data which has been used for execution of the input-output processing immediately before powering from the AC power source 3 to the memory 13 is stopped is stored in the memory 13 and hence is allowed to effectively utilize the data in the memory 13 when powering is started. As a result, even if it is impossible to refer to the information about the memory 13 stored in the flash memory 14 due to the abnormality in the flash memory 14, the control device 10 will be allowed to effectively utilize the data which has been used for execution of the input-output processing immediately before powering from the AC power source 3 to the memory 13 is stopped.

Incidentally, in the above mentioned embodiment 1, the case in which the single control device 10 effectively utilizes the memory 13 regardless of occurrence of abnormality in the flash memory 14 that holds the information about the memory 13 when powering from the AC power source 3 to the memory 13 has been stopped and then started again has been described. However, the present technique is not limited to the above mentioned case and may be configured such that control devices 10 and 30 of dual configuration effectively utilize memories 13 and 33 regardless of occurrence of abnormality in a flash memory or memories 14 and/or 34 that hold(s) information about a memory or memories 13 and/or 33 when powering from the AC power source 3 to the memory 13 has been stopped and then started again.

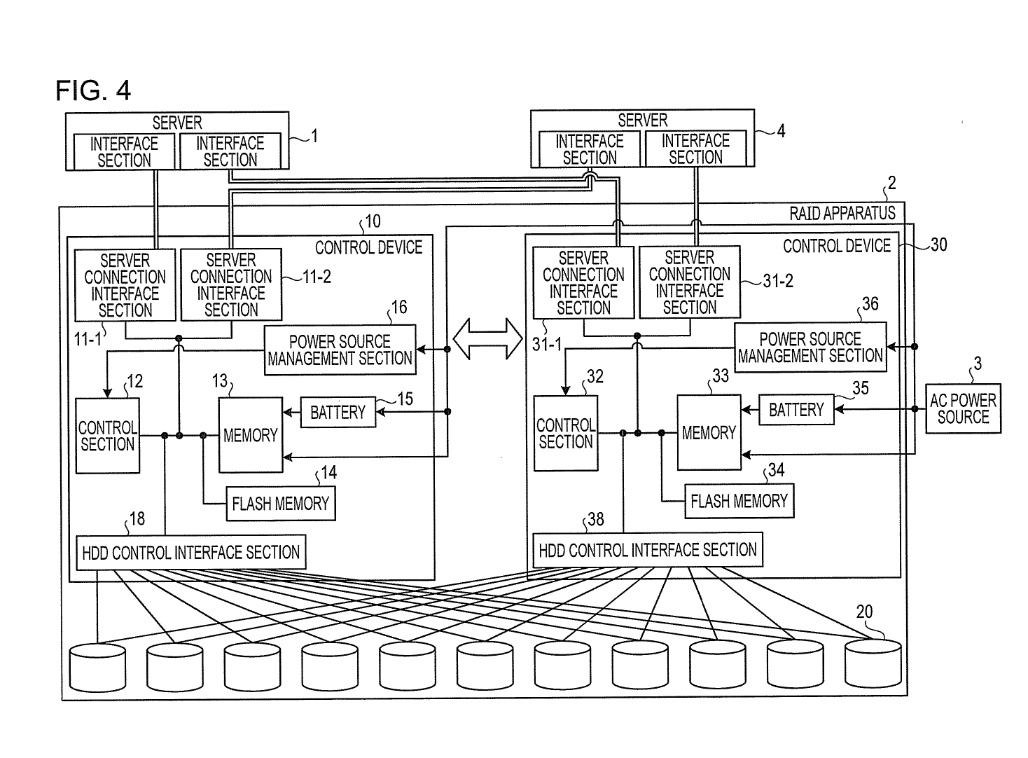

Thus, in an embodiment 2, the case in which both the control devices 10 and 30 of dual configuration effectively utilize the memories 13 and 33 regardless of occurrence of abnormality in the flash memory or memories 14 and/or 34 that hold(s) information about the memory or memories 13 and/or 33 when powering from the AC power source 3 to the memory 13 has been stopped and then started again will be described. First, the general configuration of an RAID system according to the embodiment 2 will be described with reference to FIG. 4. FIG. 4 is a diagram illustrating an example of the general configuration of the RAID system according to the embodiment 2. As illustrated in FIG. 4, in the RAID system according to the embodiment 2, a server 4 and the control device 30 are added to the configuration of the RAID system (FIG. 1) according to the embodiment 1. In the example illustrated in FIG. 4, the same numerals are assigned to the same parts as those in FIG. 1 and detailed description thereof will be omitted.

The servers 1 and 4 constitute upper apparatuses of the RAID apparatus 2 and command input-output requests to the RAID apparatus 2. The server 1 is connected to the control devices 10 and 30 of the RAID apparatus 2 via a connection path. Likewise, the server 2 is connected to the control devices 10 and 30 of the RAID apparatus 2 via a connection path as in the case with the server 1.

The control devices 10 and 30 constitute a dual control device and, when the commands of the same input-output request are acquired respectively from the servers 1 and 4, operate in synchronization with each other such that the data in the memory 13 is made the same as that in the memory 33 and operate to store the data of the same contents in the storage devices 20. In the following description, the control device 10 is supposed to be a “0” system and the control device 30 is supposed to be a “1” system. In addition, although the functions of the control device 10 will be described hereinbelow, the functions of the control device 30 are the same as those of the control device 10 and hence description thereof will be omitted.

A server connection interface section 11-1 is an interface used for data exchange between the server 1 and the RAID apparatus 2 and a server connection interface section 11-2 is an interface used for data exchange between the server 4 and the RAID apparatus 2.

When abnormality which may a factor for stopping powering from the AC power source 3 to the memory 13 is sensed while processing in accordance with the input-output requests from the servers 1 and 4 is being executed, the control section 12 operates to write the sensed factor for abnormality (hereinafter, referred to as an abnormality factor) into the memory 13. Incidentally, the abnormality factor includes a factor that may induce abnormality in the control devices 10 and 30 simultaneously and a factor that may induce abnormality in the control devices 10 and 30 at different times. As the factor for simultaneously inducing abnormality in the control devices 10 and 30, service interruption is given by way of example. As the factor for inducing abnormality in the control devices 10 and 30 at different times, there are given factors for inducing abnormality in each control device (10, 30) such as a factor inducing abnormality in powering other than the service interruption and a factor inducing abnormality such as a malfunction of a functional section installed in the control device (10, 30). However the factors for inducing abnormality are not limited to the above mentioned factors.

The control section 12 operates to judge whether the data which has been the object of input-output processing is present in the memory 13 after powering from the AC power source 3 to the memory 13 has been temporally stopped and resumed, and when the data concerned has been judged to be present in the memory 13, to judge whether the data concerned is the latest one. Specifically, the control section 12 operates to judge whether the information indicating that the data concerned is present in the memory 13 is stored in the flash memory 14. In the above mentioned situation, when it is sensed that the flash memory 14 is abnormal, the control section 12 operates to read out data from an arbitrary address of the memory 13 and to judge whether an error in the read-out data has been detected. When it has been judged that the error in the data is not detected, the control section 12 operates to read out an abnormality factor from the memory 13 and to judge whether the read-out abnormality factor is of the type that may induce abnormality in the O-system and the other system (1-system) simultaneously. In the case that it has been judged that the abnormality factor is of the type that may induce abnormality in the system (the O-system) and the other system (the 1-system) simultaneously, it is found that the control devices 10 and 30 of both the systems are simultaneously shut down and hence the same latest data is stored in both the memories (13, 33), so that the control section 12 operates to continue execution of the input-output processing using the data stored in the memory 13. On the other hand, when it has been judged that the abnormality factor is not of the type that may induce abnormality in the system (the O-system) and the other system (the O-system) simultaneously, the control section 12 is not allowed to discriminate as to in which system the abnormality has been sensed earlier, the system (the O-system) or the other system (the 1-system) and is not allowed to judge as to which piece of data stored in the memories (13, 33) is the latest and hence operates to initialize the memory 13 in order to delete the data concerned.

Incidentally, when it has been judged that the flash memory 14 is not abnormal, that is, the information indicating that the data concerned is present in the memory 13 is stored in the flash memory 14, the control section 12 operates to judge whether the information indicating that the data is not the latest is stored in the flash memory 14. In the example illustrated in the drawing, the information indicating that the data is not the latest is information indicating that the data in the memory 13 is not the latest. In the case that abnormality has occurred in the control device 10 earlier than in the control device 30, the control device 10 operates to terminate execution of the input-output processing earlier than the control device 30, so that the data in the memory 13 of the control device 10 will become older than that in the memory 33 of the control device 30. That is, the data in the memory 13 is not the latest. Thus, the control device 30 operates to store the information indicating that the data in the memory 13 of the control device 10 is not the latest in the flash memory 14 of the control device 10. Then, when the information indicating that the data is not the latest is stored in the flash memory 14, the control section 12 operates to initialize the memory 13, while when the information indicating that the data is not the latest is not stored in the flash memory 14, the control section 12 operates to continue execution of the input-output processing using the data stored in the memory 13.

As a result, even if abnormality occurs in the flash memory in which the information that the data in the memory 13 is not the latest is stored, the control device 10 will operate to determine whether the data in the memory is the latest in accordance with the abnormality factor stored in the memory 13. Therefore, it is allowed to continue execution of the input-output processing using the data stored in the memory 13 only when the data in the memory 13 is the latest. As a result, the control device 10 is allowed to operate so as to prevent the data in the memories 13 and 33 of the both systems from mismatching.

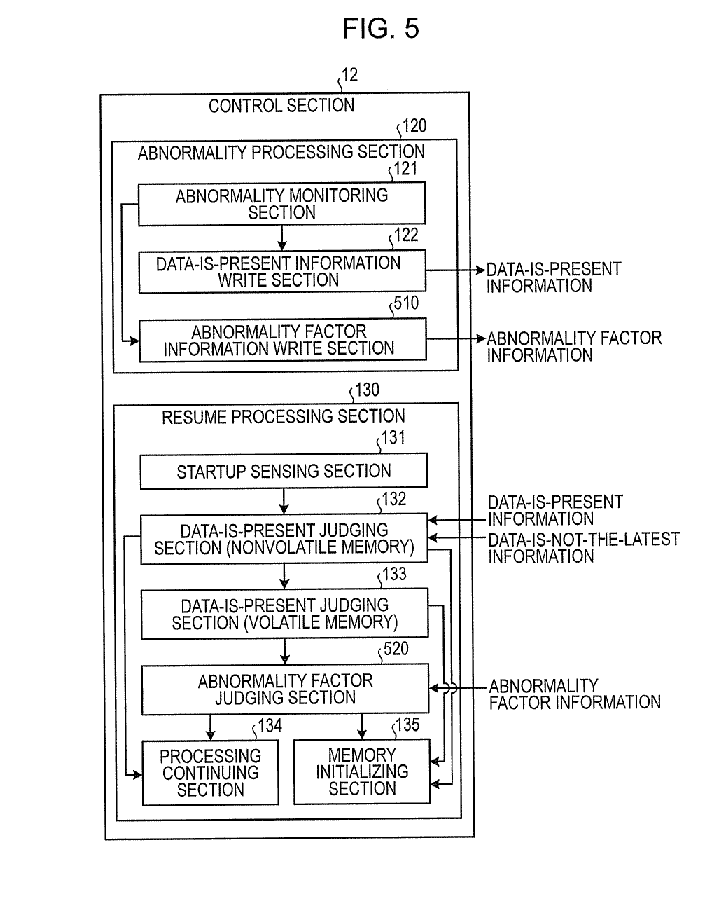

Next, a configuration of the control section 12 according to the embodiment 2 will be described with reference to FIG. 5. FIG. 5 is a functional block diagram illustrating a configuration of the control section 12 according to the embodiment 2. As illustrated in FIG. 5, an abnormality factor write section 510 and an abnormality factor judging section 520 are added to the control section 12 (FIG. 2) according to the embodiment 1 to constitute the control section 12 according to the embodiment 2. In the example illustrated in FIG. 5, the same numerals are assigned to the same parts as those in FIG. 2 and detailed description thereof will be omitted. Incidentally, the functions of the control section 32 are the same as those of the control section 12 and hence description thereof will be omitted.

When the abnormality monitoring section 121 monitors the notification of “memory powering abnormality” output from the power source management section 16 and each functional section in the control device 10 and senses the “memory powering abnormality”, it notifies the data-is-present information write section 122 and the abnormality factor information write section 510 that the “memory powering abnormality” has occurred. For example, the information indicating that the “memory powering abnormality” has occurred is acquired from the power source management section 16 and each functional section in the control device 10 together with the factor of abnormality which has induced the “memory powering abnormality”, the abnormality monitoring section 121 notifies the data-is-present information write section 122 of the “memory powering abnormality” and notifies the abnormality factor information write section 510 of the abnormality factor.

When the abnormality factor is received from the abnormal monitoring section 121, the abnormality factor information write section 510 writes the abnormality factor information including the sensed abnormality factor into the memory 13.

The data-is-present judging section 132 in the nonvolatile memory judges whether the data which has been the object of input-output processing is present in the memory 13. When the data concerned has been judged to be present in the memory 13, the data-is-present judging section 132 in the nonvolatile memory judges whether the data concerned is the latest data. Specifically, the data-is-present judging section 132 in the nonvolatile memory judges whether the information indicating that the data concerned is present in the memory 13 is stored in the flash memory 14. In the above mentioned situation, when the data-is-present judging section 132 in the nonvolatile memory senses that the flash memory 14 is abnormal, it notifies the data-is-present judging section 133 in the volatile memory that the flash memory 14 is abnormal.

When it has been judged that the information indicating that the data concerned is present in the memory 13 is stored in the flash memory 14, the data-is-present judging section 132 in the nonvolatile memory judges whether the information indicating that the data in the memory 13 is not the latest is stored in the flash memory 14. When it has been judged that the information indicating that the data in the memory 13 is not the latest data is not stored in the flash memory 14, the data-is-present judging section 132 in the nonvolatile memory notifies the processing control section 134 that the data in the memory 13 is the latest. On the other hand, when it has been judged that the information indicating that the data in the memory 13 is not the latest is stored in the flash memory 14, the data-is-present judging section 132 in the nonvolatile memory notifies the memory initializing section 135 that the data in the memory 13 is not the latest. Incidentally, when it has been judged that the information indicating that the data concerned is present in the memory 13 is not stored in the flash memory 14, the data-is-present judging section 132 in the nonvolatile memory notifies the memory initializing section 135 that the data which has been the object of input-output processing is not present in the memory 13.

The data-is-present judging section 133 in the volatile memory judges whether the data which has been the object of input-output processing is present in the memory 13. Specifically, when the notification that the flash memory 14 is abnormal is received from the data-is-present judging section 132 in the nonvolatile memory, the data-is-present judging section 133 in the volatile memory judges whether an error in the data is detected. When it has been judged that the error in the data is not detected, the data-is-present judging section 133 notifies the abnormality factor judging section 520 that the data which has been the object of input-output processing is present in the memory 13. On the other hand, when it has been judged that the error in the data is detected, the data-is-present judging section 133 notifies the memory initializing section 135 that the data which has been the object of input-output processing is not present in the memory 13.

The abnormality factor judging section 520 judges whether the data in the memory 13 is the latest data. Specifically, when the notification that the data which has been the object of input-output processing is present in the memory 13 is received from the data-is-present judging section 133 in the volatile memory, the abnormality factor judging section 520 reads out the abnormality factor information from the memory 13 and judges whether the abnormality factor included in the read-out abnormality factor information is the factor (for example, service interruption) that may induce abnormality in the own system and the other system (the 1-system) simultaneously. When it has been judged that the factor is the one that may induce the abnormality in the own system and the other system (the 1-system) simultaneously, it is found that the data in the memory 13 is the latest one and hence the abnormality factor judging section 520 notifies the processing control section 134 that the data in the memory 13 is the latest. On the other hand, when it has been judged that the abnormality factor is not the factor that may induce the abnormality in the own system and the other system (the 1-system) simultaneously, it is not allowed to judge whether the data in the memory 13 is the latest, so that the abnormality factor judging section 520 notifies the memory initializing section 135 that the data in the memory 13 is not the latest.

When the notification that the data in the memory 13 is the latest is received from the data-is-present judging section 132 in the nonvolatile memory or the abnormality factor judging section 520, the processing control section 134 continues execution of the input-output processing using the data stored in the memory 13.

When the notification that the data which has been the object of the input-output processing is not present in the memory 13 or the data in the memory 13 is not the latest is received from the data-is-present judging section 133 in the volatile memory or the abnormality factor judging section 520, the memory initializing section 135 initializes the memory 13.

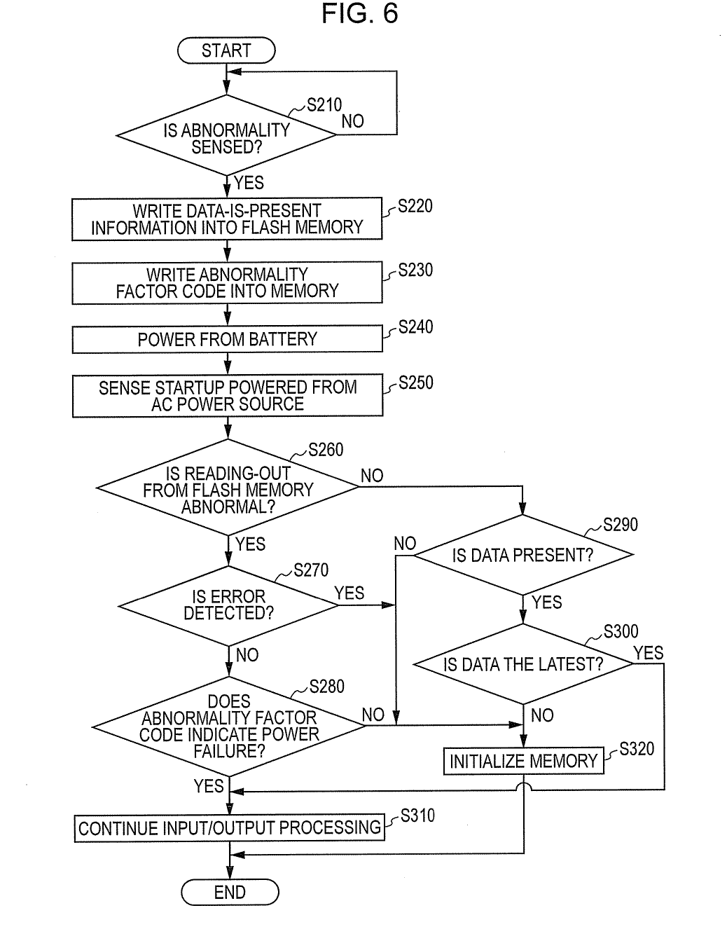

Next, processing executed by the control device according to the embodiment 2 will be described with reference to FIG. 6. FIG. 6 is a flowchart illustrating the processing executed by the control device according to the embodiment 2. Incidentally, description will be made on the assumption that powering from the AC power source 3 to the memory 13 has been stopped while the control device 10 is operating to execute the input-output processing.

First, the abnormality monitoring section 121 of the abnormality processing section 120 monitors the notification “memory powering abnormality” output from the power source management section 16 and each functional section in the control device 10 and judges whether the “memory powering abnormality” has been sensed (S210). In the above mentioned case, when the “memory powering abnormality” is not sensed (No at S210), the abnormality monitoring section 121 repeats the same judging process until the “memory powering abnormality” is sensed.

On the other hand, when the “memory powering abnormality” is sensed (Yes at S210), the abnormality monitoring section 121 notifies the data-is-present information write section 122 of occurrence of the “memory powering abnormality” and notifies the abnormality factor information write section 510 of the abnormality factor. Then, the data-is-present information write section 122 which has received the notification that the “memory powering abnormality” has occurred writes the information indicating that the data concerned is present in the memory 13 into the flash memory 14 (S220). Incidentally, in the case that abnormality has occurred in the control device 10 earlier than in the control device 30, information indicating that the data in the memory 13 is not the latest is written into the flash memory 14 of the control device 10 under the control of the control device 30.

The abnormality factor information write section 510 which has received the factor of the abnormality concerned writes an abnormality factor code corresponding to the received abnormality factor into the memory 13 (S230).

Then, the battery 15 starts powering to the memory 13 (S240). Then, the control device 10 is shut down and powering from the AC power source 3 is stopped.

Then, when the control device 10 is again powered from the AC power source 3, the startup sensing section 131 senses that the AC power source 3 has been turned on (S250) and notifies the data-is-present judging section 132 in the nonvolatile memory that the AC power source 3 has been turned on.

The data-is-present judging section which has received the notification that the AC power source 3 has been turned on judges whether the flash memory 14 is abnormal (S260). Specifically, when the information indicating that the data concerned is present in the memory 13 is read out from the flash memory 14, the data-is-present judging section 132 in the nonvolatile memory judges whether reading-out from the flash memory 14 is abnormal.

When it has been judged that the flash memory 14 is abnormal (Yes at S260), the data-is-present judging section 132 in the nonvolatile memory notifies the data-is-present judging section 133 in the volatile memory that the flash memory 14 is abnormal.

The data-is-present judging section 133 which has received the notification that the flash memory 14 is abnormal from the data-is-present judging section 132 in the nonvolatile memory reads out data from an arbitrary address of the memory 13 and judges whether an error in the read-out data is detected (S270).

Judgment that the error in the data is not detected (No at S270) means that an error detection code is added to the data in the memory 13 and hence the data-is-present judging section 133 in the volatile memory notifies the abnormality factor judging section 520 that the data which has been the object of the input-output processing is present in the memory 13.

On the other hand, when it has been judged that the error in the data is detected (Yes at S270), a notification that the data which has been the object of the input-output processing is not present in the memory 13 is sent to the memory initializing section 135.

The abnormality factor judging section 520 which has received the notification that the data which has been the object of the input-output processing is present in the memory 13 from the data-is-present judging section 133 in the volatile memory judges whether an abnormality factor code stored in the memory 13 is of service interruption (a factor that may induce abnormality simultaneously in the own system and the other system) (S280).

When it has been judged that the abnormality factor code is a code indicative of service interruption (Yes at S280), since the service interruption is a factor that may induce abnormality simultaneously in the own system and the other system, the abnormality factor judging section 520 notifies the processing control section 134 that the data in the memory 13 is the latest.

On the other hand, when it has been judged that the abnormality factor code is not a code indicative of service interruption (No at S280), the abnormality factor judging section 520 notifies the memory initializing section 135 that the data in the memory 13 is not the latest.

When it has been judged that the flash memory 14 is normal (No at S260), the data-is-present judging section 132 in the nonvolatile memory judges whether information indicating that the data concerned is present in the memory 13 is stored in the flash memory 14 (S290).

When it has been judged that the information indicating that the data concerned is present in the memory 13 is stored in the flash memory 14 (Yes at S290), the data-is-present judging section 132 in the nonvolatile memory judges whether information indicating that the data in the memory 13 is not the latest is stored in the flash memory 14 (S300).

On the other hand, when it has been judged that the information indicating that the data concerned is present in the memory 13 is not stored in the flash memory 14 (No at S290), a notification that the data which has been the object of the input-output processing is not present in the memory 13 is sent to the memory initializing section 135.

When it has been judged that the information indicating that the data in the memory 13 is not the latest is stored in the flash memory 14 (No at S300), a notification that the data in the memory 13 is not the latest is sent to the memory initializing section 135.

On the other hand, when it has been judged that the information indicating that the data in the memory 13 is not the latest is not stored in the flash memory 14 (Yes at S300), a notification that the data in the memory 13 is the latest is sent to the processing control section 134.

Then, the memory initializing section 135 initializes the memory 13 when it has received a notification that the data which has been the object of the input-output processing is not present in the memory 13 or the data in the memory 13 is not the latest from the data-is-present judging section 132 in the nonvolatile memory or when it has received a notification that the data in the memory 13 is not the latest from the data-is-present judging section 133 in the volatile memory (S320). In addition, the control section 12 operates to notify the server 1 that the data in the memory 13 may be unrecovered, and the control section 12 operates to stop the RAID apparatus 2, as a recovery processing.

Then, the processing control section 134 continues execution of the input-output processing using the data stored in the memory when it has received a notification that the data in the memory 13 is the latest from the data-is-present judging section 132 in the nonvolatile memory or when it has received a notification that the data in the memory 13 is the latest from the data-is-present judging section 133 in the volatile memory (S310).

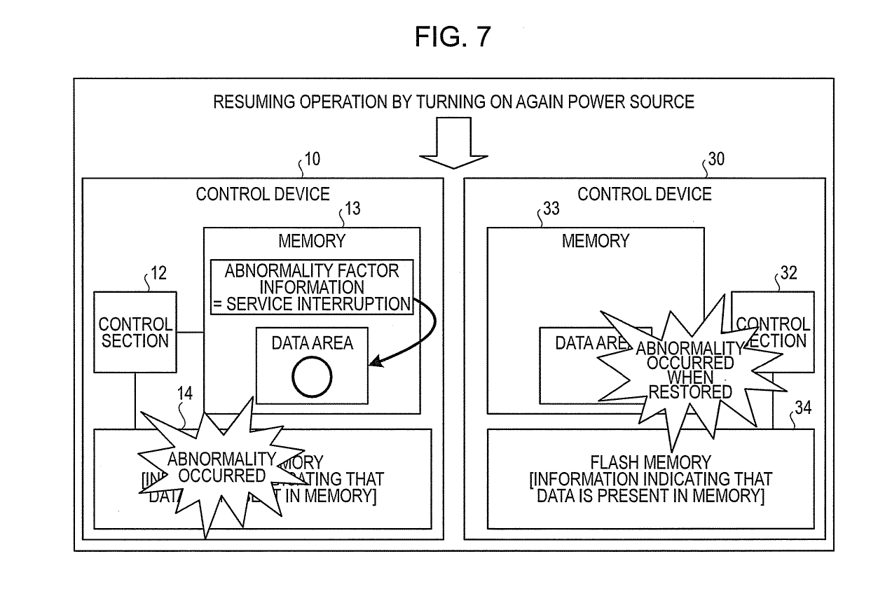

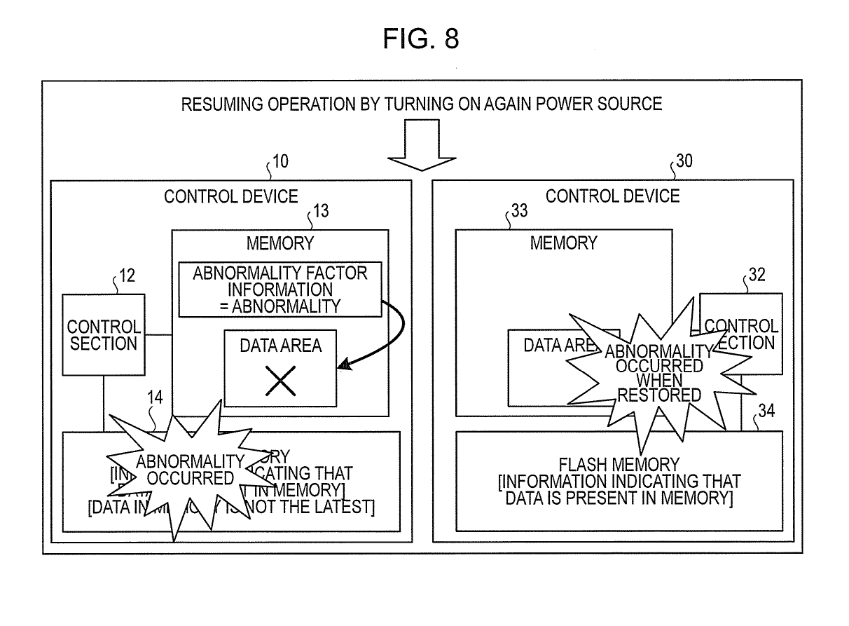

Next, a resuming operation performed on the control device in accordance with each abnormality factor will be described with reference to FIGS. 7 and 8. An example that the abnormality factor is service interruption which is a factor that may induce abnormality simultaneously in the own system and the other system will be described with reference to FIG. 7 and an example that the abnormality factor is a factor other than the service interruption, that is, a factor that may induce abnormality in the own system and the other system at different times will be described with reference to FIG. 8.

FIG. 7 is a diagram illustrating a resuming operation performed on the control device when the abnormality factor is service interruption. As illustrated in FIG. 7, information indicating that data is present in the memory 13 is stored in the flash memory 14 of the control device 10 powering from the AC power source 3 to which has been stopped due to occurrence of service interruption and abnormality factor information indicative of the service interruption is stored in the memory 13 of the control device 10. Then, when abnormality has occurred in the flash memory 14, the control unit 10 powering from the AC power source 3 to which has been again turned on is not allowed to operate so as to refer to information about the memory 13 which is stored in the flash memory 14, so that the control device 10 operates to refer to the abnormality factor information stored in the memory 13. Then, since the abnormality factor information is of the service interruption, it is found that the data in the memory 13 is the latest and hence the control device 10 is resumed using the data stored in the memory 13.

In the above mentioned case, even if some abnormality freshly occurs while a resuming operation is being performed after powering from the AC power source has been again turned on, the control device 30 powering from the AC power source 3 to which has been stopped as in the case with the control device will be allowed to operate so as to correctly resume the memory 33 later using the data in the memory 13 because the data in the memory 13 of the control device 10 is the latest.

FIG. 8 is a diagram illustrating a resuming operation performed on the control device for an abnormality factor other than the service interruption. Incidentally, in the example illustrated in FIG. 8, it is supposed that abnormality has occurred in the control device 10 earlier than in the control device 30. As illustrated in FIG. 8, information indicating that data is present in the memory 13 and information indicating that the data in the memory 13 is not the latest are stored in the flash memory 14 of the control device 10 powering from the AC power source 3 to which has been stopped due to the abnormality factor other than the service interruption. In addition, abnormality factor information indicative of the abnormality factor other than the service interruption is stored in the memory 13. When abnormality has occurred in the flash memory 14, the control device 10 powering from the AC power source 3 to which has been again turned on is not allowed to operate so as to refer to information about the memory 13 stored in the flash memory 14. Therefore, the control device 10 operates to refer to the abnormality factor information stored in the memory 13. Then, since the abnormality factor information is of the abnormality factor other than the service interruption and the abnormality is not the one that has occurred simultaneously in the control devices 10 and 30, it may be feared that the data in the memory 13 is not the latest. Therefore, the control device 10 operates to delete the data stored in the memory 13. As a result, the control device 10 is allowed to operate so as to correctly delete the data in the memory 13 which may not be the latest, thereby preventing resumption from being erroneously performed using the data which may not be the latest.

In the above mentioned case, even if some abnormality freshly occurs while a resuming operation is being performed after powering from the AC power source 3 has been turned on again, the control device 30 powering from the AC power source 3 to which has been stopped as in the case with the control device 10 will be allowed to operate so as to prevent the memory 33 from being erroneously resumed using the data which may not be the latest and is stored in the memory 13 in future.

As described above, according to the present embodiment, the control device 10 operates to store the data used for execution of the input-output processing concerned by being powered from the AC power source 3 while the input-output processing which has been instructed from the server (1, 4) is being executed. Then, the control device 10 operates to judge whether the error detection code is added to the data stored in the memory 13 when powering from the AC power source 3 to the memory 13 has been started again after temporarily stopped. Then, the control device 10 operates to judge whether the abnormality factor information which has been written into the memory 13 is of the factor that induces the abnormality simultaneously in itself and the control device 30 of the other system when it has been judged that the error detection code is added to the data stored in the memory 13. Then, the control device 10 operates to continue execution of the input-output processing using the data stored in the memory 13 when it has been judged that the factor is the one that induces abnormality simultaneously in itself and the control device 30 of the other system.

Since the control device 10 is allowed to operate so as to judge whether the data in the memory is the latest with reference to the abnormality factor information stored in the memory 13 even upon occurrence of abnormality in the flash memory 14, if the data in the memory 13 is the latest, the data which has been used for execution of the input-output processing immediately before the powering from the AC power source 3 to the memory 13 is stopped will be effectively utilized.

Incidentally, in the above embodiment 1, the case in which the single control device 10 operates to effectively utilize the memory 13 even upon occurrence of abnormality in the flash memory 14 that holds the information relating to the memory 13 after powering from the AC power source to the memory 13 has been stopped and started again has been described. However, the present technique is not limited to the above case and may include the case in which both the control devices 10 and 30 of dual configuration operate to effectively utilize memories 13 and 33 even upon occurrence of abnormality in one of flash memories 14 and 34 that hold information relating to the memories 13 and 33 after powering from the AC power source 3 to the memory 13 has been temporarily stopped and started again. In the above mentioned case, in the above mentioned embodiment 2, both the control devices 10 and 30 of dual configuration operate to judge whether the data in the memories 13 and 33 is the latest with reference to the abnormality factor information stored in the memories 13 and 33 even upon occurrence of abnormality in one of the flash memories 14 and 34 when powering from the AC power source 3 to the memory 13 has been stated again after temporarily stopped. However, the present technique is not limited to the above mentioned case and may be configured such that both the control devices 10 and 30 of dual configuration operate to judge whether the data in the memories 13 and 33 is the latest with reference to information stored in the memories 13 33 under the instruction from the control device 30 or 10 of the other system even upon occurrence of abnormality in one of the flash memories 14 and 34 when powering from the AC power source 2 to the memory 13 has been started again after temporarily stopped.

Therefore, in an embodiment 3, the case in which both the control devices 10 and 30 of dual configuration operate to judge whether the data in the memories 13 and 33 is the latest with reference to information stored in the memories 13 and 33 under the instruction from the control device of the other system 30 or 10 even upon occurrence of abnormality in one of the flash memories 14 and 34 when powering from the AC power source 3 to the memory 13 has been started again after temporarily stopped will be described. Incidentally, the general configuration of the RAID system according to the embodiment 3 is the same as that of the RAID system according to the embodiment 2 and hence description thereof will be omitted.

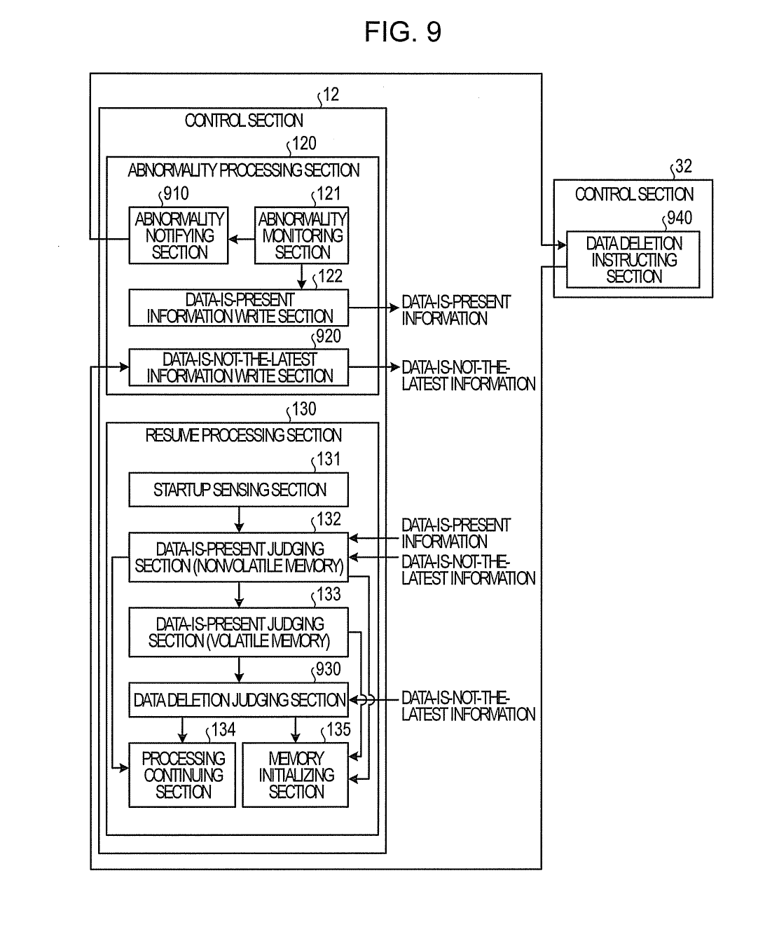

Next, the configurations of the control sections 12 and 32 according to the embodiment 3 will be described with reference to FIG. 9. FIG. 9 is a functional block diagram illustrating the configuration of the control section 12 according to the embodiment 3. As illustrated in FIG. 9, an abnormality notifying section 910 and a write section that writes information indicating that data is not the latest (hereinafter, referred to as a data-is-not-the-latest information write section) 920 are added to the control section 12 (FIG. 5) according to the embodiment 2 to constitute the control section 12 according to the embodiment 3. Then, in the control section 12 according to the embodiment 3, the abnormality factor judging section 520 is replaced by a data deletion judging section 930. In addition, the control section 32 according to the embodiment 3 includes a data deletion instructing section 940. Incidentally, in the example illustrated in FIG. 9, the same numerals are assigned to the same parts as those in FIG. 5 and detailed description thereof will be omitted.

When information indicative of the “memory powering abnormality” has been acquired from the abnormality monitoring section 121, the abnormality notifying section 910 notifies the control section 32 of the control device 30 of the information indicative of the “memory powering abnormality” so as to make the control device 10 notify the control device 30 of the other system that powering from the AC power source 3 to the memory 13 will be stopped. Incidentally, in the case that abnormality has occurred in the control device 10 later than in the control device 30, the control device 10 is no longer in synchronization with the control device 30 when the abnormality has occurred in the control device 10, so that the control device 10 may need not operate to notify the control device 30 of the above mentioned information.

When a notification that the data in the memory 13 is not the latest is received from the data deletion instructing section 940 of the control section 32, the data-is-not-the-latest information write section 920 writes data-is-not-the-latest information indicating that the data in the memory 13 is not the latest into the memory 13. Incidentally, the data-is-not-the-latest information is information indicating that the data in the memory 13 is not the latest. In the case that abnormality has occurred in the control device 10 earlier than in the control device 30, the control device 10 operates to terminate the execution of the input-output processing earlier than the control device 30, so that the data in the memory 13 of the control device 10 gets older than that in the memory 33 of the control device 30. That is, the data in the memory 13 is no longer the latest.

The data deletion judging section 930 judges whether the data in the memory 13 of the control device 10 is the latest. Specifically, when a notification that data which has been the object of the input-output processing is present in the memory 13 is received from the data-is-present judging section 133 in the volatile memory, the data deletion judging section 930 judges whether the data-is-not-the-latest information is present in the memory 13. Then, when it has been judged that the data-is-not-the-latest information is present in the memory 13, it is found that the data in the memory 13 is not the latest and hence the data deletion judging section 930 notifies the memory initializing section 135 that the data in the memory 13 is not the latest. On the other hand, when it has been judged that the data-is-not-the-latest information is not present in the memory 13, it is found that the data in the memory 13 is the latest and hence the data deletion judging section 930 notifies the processing control section 134 that the data in the memory 13 is the latest.

If information indicative of the “memory powering abnormality” is received from the abnormality notifying section 910 of the control device 10, the control device 10 will operate to terminate execution of the input-output processing earlier than the own device (the control device 30) due to the “memory powering abnormality” and hence the data in the memory 13 of the control device 10 will get older than that in the memory 33 of the own device (the control device 30), so that the data deletion instructing section 940 notifies the data-is-not-the-latest information write section 920 of the information indicating that the data in the memory 13 of the control device 10 is not the latest.

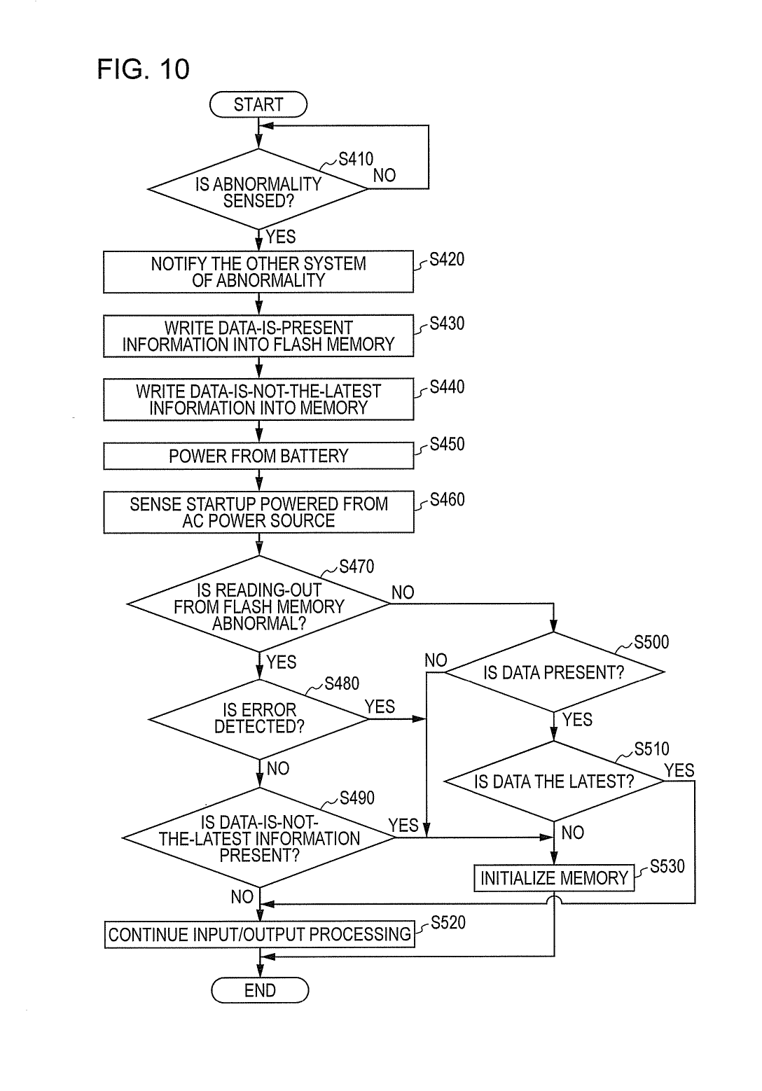

Next, processing executed by the control device according to the embodiment 3 will be described with reference to FIG. 10. FIG. 10 is a flowchart illustrating the processing executed by the control device according to the embodiment 3. Incidentally, description will be made on the assumption that powering from the AC power source 3 to the memory 13 is stopped before powering to the control device 30 is stopped while the control device 10 is executing the input-output processing.

First, the abnormality monitoring section 121 of the abnormality processing section 120 monitors the notification of the “memory powering abnormality” output from the power source monitoring section 16 and each functional section in the control device 10 and judges whether the “memory powering abnormality” has been sensed (S410). In the above mentioned situation, when the “memory powering abnormality” is not sensed (No at S410), the abnormality monitoring section 121 repeats the same judging process until the “memory powering abnormality” is sensed.

On the other hand, when the “memory powering abnormality” is sensed (Yes at S410), the abnormality monitoring section 121 notifies the data-is-present information write section 122 and the abnormality sensing section 910 that the “memory powering abnormality” has been sensed. Incidentally, in the example illustrated in FIG. 10, powering from the AC power source 3 to the memory 13 of the control device 10 has been stopped before powering to the memory of the control device 30 is stopped, so that the “memory powering abnormality” sensed by the abnormality monitoring section 121 includes abnormality such as, for example, powering abnormality due to a factor other than service interruption and abnormality such as a malfunction of a functional section (such as the CPU) installed in the control device.

The abnormality notifying section 910 which has received the notification of “memory powering abnormality” notifies the data deletion instructing section 940 of the control device 30 of the other system of the information that the own device (the control device 10) is in the “memory powering abnormality” occurred state (S420). The data-is-present information write section 122 which has received the notification that the own device is in the “memory powering abnormality” occurred state writes the information indicating that the data is present in the memory 13 into the flash memory 14 (S430). Incidentally, the “memory powering abnormality” has occurred in the control device 10 earlier than in the control device 30, the information indicating that the data in the memory 13 is not the latest is written into the flash memory 14 under the control of the control device 30.

In addition, the data-is-not-the-latest information write section 920 which has received the information that the data in the memory 13 is not the latest from the data deletion instructing section 940 of the control device 30 of the other system writes the data-is-not-the-latest information indicating that the data in the memory 13 is not the latest into the memory 13 (S440).

Then, the battery 15 starts powering to the memory 13 (S450). Then, the control device 10 is shut down and powering from the AC power source 3 to the memory 13 is stopped.

Then, when the control device 10 is again powered from the AC power source 3, the startup sensing section 131 senses that the AC power source 3 has been turned on (S460) and notifies the data-is-present judging section 132 in the nonvolatile memory that the AC power source 3 has been turned on.

The data-is-present judging section 132 in the nonvolatile memory has received the notification that the AC power source 3 has been turned on, and judges whether the flash memory 14 is abnormal (S470). Specifically, the data-is-present judging section 132 in the nonvolatile memory judges whether abnormality occurs in reading when information indicating that the data is present in the memory 13 is read out from the flash memory 14.

When it has been judged that the flash memory 14 is abnormal (Yes at S470), the data-is-present judging section 132 in the nonvolatile memory notifies the data-is-present judging section 133 in the volatile memory that the flash memory 14 is abnormal.

The data-is-present judging section 133 which has received from the data-is-present judging section 132 in the nonvolatile memory the notification that the flash memory 14 is abnormal reads out data from an arbitrary address of the memory 13 and judges whether an error in the data is detected (S480).

When it has been judged that the error in the data is not detected (No at S480), the data-is-present judging section 133 in the volatile memory finds that an error detection code is added to the data in the memory 13 and hence notifies the data deletion judging section 930 that the data which has been the object of input-output processing is present in the memory 13.

On the other hand, when it has been judged that the error in the data is detected (Yes at S480), the data-is-present judging section 133 notifies the memory initializing section 135 that the data which has been the object of the input-output processing is not present in the memory 13.

The data deletion judging section 930 which has received from the data-is-present judging section 133 in the volatile memory the notification that the data which has been the object of the input-output processing is present in the memory 13 judges whether the data-is-not-the-latest information is present in the memory 13 (S490).

When it has been judged that the data-is-not-the-latest information is not present in the memory 13 (No at S490), it is found that the data in the memory 13 is the latest and hence the data deletion judging section 930 notifies the processing control section 134 that the data in the memory 13 is the latest. Then, the processing control section 134 continues execution of the input-output processing using the data stored in the memory 13 (S520).

On the other hand, when the data-is-not-the-latest information has been judged to be present in the memory 13 (Yes at S490), it is found that the data in the memory 13 is not the latest and hence the data deletion judging section 930 notifies the memory initializing section 135 that the data in the memory 13 is not the latest. Then, the memory initializing section 135 initializes the memory 13 (S530).

Incidentally, the processes to be executed in the case that the flash memory 4 has been judged to be normal (No at S470) are the same as the processes (S290 to S320 in FIG. 6) executed by the control device according to the embodiment 2 and hence description thereof will be omitted (S500 to S530).

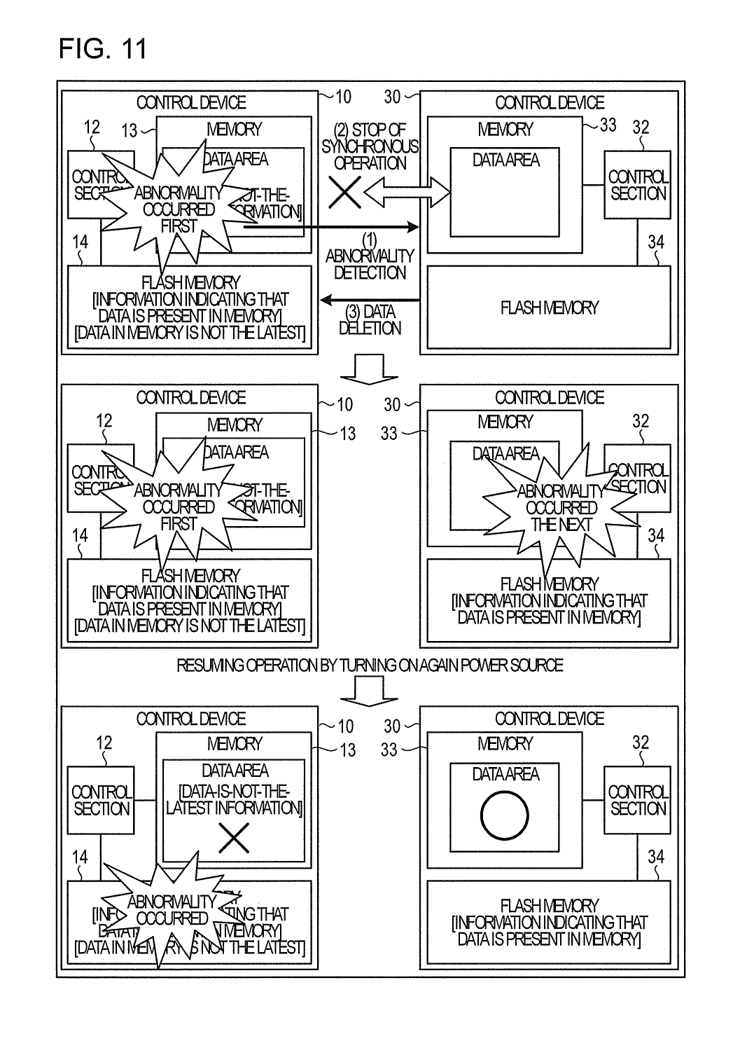

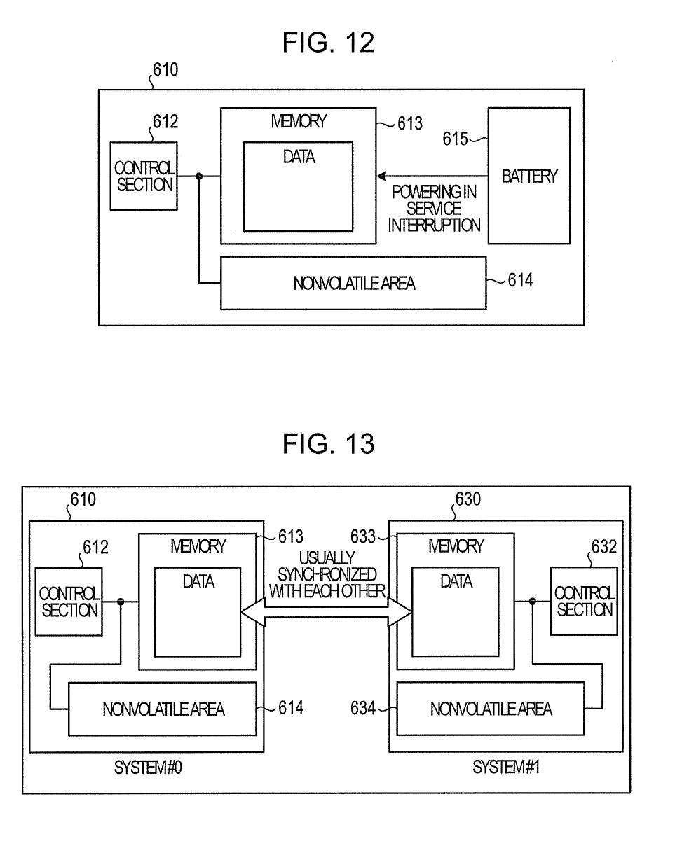

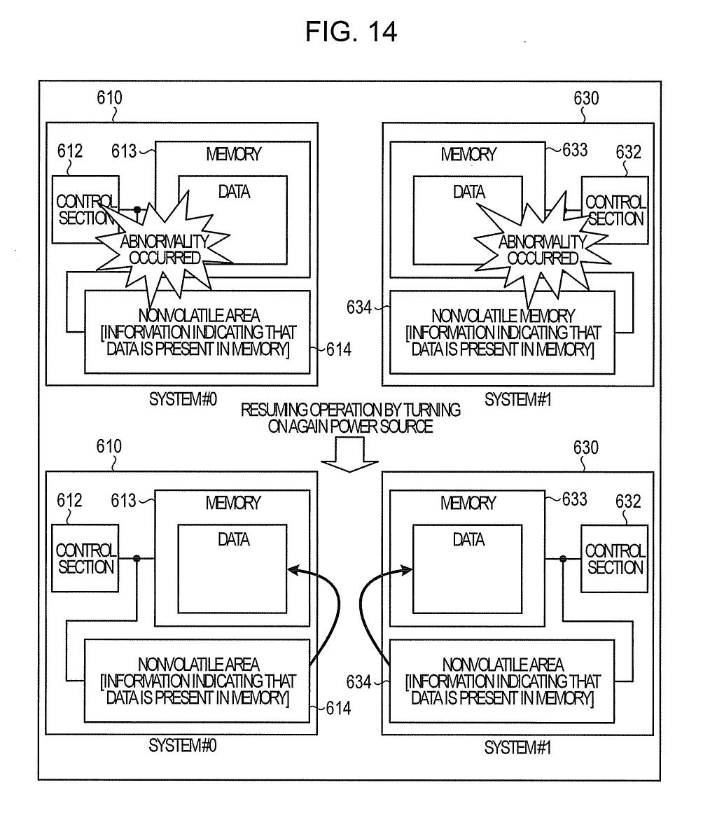

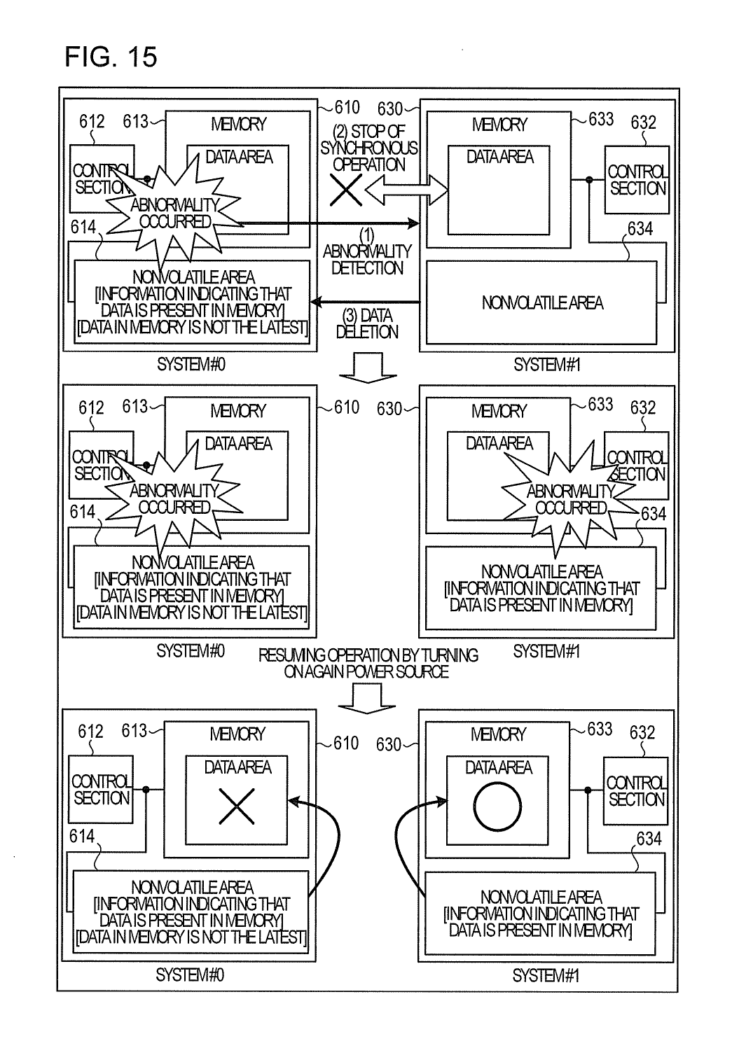

Next, an example of a resuming operation performed on the control device according to the embodiment 3 will be described with reference to FIG. 11. In the example illustrated in FIG. 11, the case in which the “memory powering abnormality” has occurred first in the control device 10 and then in the control device 30 and abnormality has occurred in the flash memory 14 of the control device 10 in which the “memory powering abnormality” has occurred first will be described. Incidentally, since the “memory powering abnormality” has occurred in the control device 10 earlier than in the control device 30, the “memory powering abnormality” includes abnormality such as, for example, powering abnormality induced by a factor other than service interruption and a malfunction of a functional section (such as the CPU) installed in the control device.

As illustrated in FIG. 11, when the “memory powering abnormality” has occurred in the control device 10 earlier than in the control device 30, the control device 30 in which the “memory powering abnormality” does not yet occur operates to detect that the “memory powering abnormality” occurs in the control device 10 (operation (1)) and to stop its synchronous operation with the control device 10 (operation (2)). Then, the control device 30 operates to notify the control device 10 that the data in the memory 13 is not the latest in order to make the control device 10 delete the data in the memory 13 (operation (3)). The control device 10 which has received the information that the data in the memory 13 is not the latest operates to write the data-is-not-the-latest information into the memory 13. In the above mentioned case, the control device 30 operates to write the information that the data in the memory 13 is not the latest into the flash memory 14 of the control device 10.

Then, when the memory powering abnormality” occurs in the control device 30 and both the control devices 10 and 30 are shut down, the AC power source is again turned on. As a result, the control device 10 is not allowed to operate so as to refer to the information indicating that the data is present in the memory 13 and the information that the data in the memory 13 is not the latest stored in the flash memory 14 due the abnormality in the flash memory 14. Therefore, the control device 10 operates to refer to the data in the memory 13 so as to judge whether the data in the memory 13 is the latest. In the above mentioned situation, since the data-is-not-the-latest information indicating that the data in the memory 13 is not the latest which has been received from the control device 30 is stored in the memory 13, the control device 10 operates to judge that the data in the memory 13 is not the latest and to delete the data in the memory 13. As a result of the above mentioned operations, the control device 10 is allowed to operate so as to correctly delete the not-the-latest data in the memory 13 to prevent its functional section from being erroneously resumed using the not-the-latest data in the memory 13.

On the other hand, when abnormality does not occur in the flash memory 34, the control device 30 operates to refer to the flash memory 34. In the above mentioned case, the information that the data in the memory 33 is not the latest is not stored in the flash memory 34, so that the control device 30 operates to resume its functional section using the data in the memory 33. Even if some abnormality freshly occurs while the control device 30 is operating to resume its functional section, the control device 30 is allowed to operate so as to prevent the memory 33 from being erroneously resumed using the not-the-latest data stored in the memory 13 of the control device 10 later.

Incidentally, in the case that abnormality has occurred in the flash memory 34 of the control device 30 in which the “memory powering abnormality” has occurred later, the “memory powering abnormality” has occurred in the control device 30 later than in the control device 10, so that it is found that the data-is-not-the-latest information is not stored in the memory 33 and the latest data is stored therein and hence the control device 30 is allowed to operate so as to correctly resume its functional section using the latest data in the memory 33.

As described above, according to the present embodiment, the control device 10 operates to notify the control device 30 which is operating in synchronization therewith that powering from the AC power source 3 to the memory 13 will be stopped when it has sensed that powering from the AC power source 3 to the memory 13 would be stopped. Then, the control device 10 operates to acquire the data-is-not-the-latest information indicating that the data stored in the memory 13 is not the latest from the control device 30 as a response to the above mentioned notification and to write the data-is-not-the-latest information into the memory 13. Then, the control device 10 operates to judge whether the data-is-not-the-latest information is stored in the memory 13, and when the data-is-not-the-latest information has been judged to be stored in the memory 13, the control device 10 operates to continue execution of the input-output processing by using the data stored in the memory 13.

In the above mentioned manner, even if the flash memory 14 is abnormal, the control device 10 will be allowed to operate so as to judge whether the data in the memory 13 is the latest with reference to the data-is-not-the-latest information stored in the memory 13. Therefore, when the data in the memory 13 is the latest, the control device 10 is allowed to operate so as to continue execution of the input-output processing and to effectively utilize the data which has been used for execution of the input-output operation immediately before powering from the AC power source 3 to the memory 13 is stopped.

Incidentally, all or some of respective processes and functions performed by the control devices 10 and 30 may be implemented by an CPU (or a microcomputer such as an MPU (Micro Processing Unit) or an MCU (Micro Controller Unit)) and programs which are analyzed and executed by the CPU (or a microcomputer such as an MPU or an MCU), or may be implemented in hardware on the basis of wired logic.

As described above, the control device, the storage apparatus and the controlling method according to embodiments will be allowed to effectively utilize the data stored in the memory when powering is started even if abnormality occurs in the nonvolatile memory that holds information for judging whether the data in the memory is reliable when powering is stopped.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A control device operable under a power supplied from a main power source, the control apparatus comprising:
a memory for storing data with an error detection code by being supplied the power from the main power source or a power from a sub power source, the data being used for execution of processing;
a judging section for judging whether an error in the data held in the memory by the power from the sub power source is detected using the error detection code after the power from the main power source to the memory has been resumed; and
a processing control section for continuing execution of the processing using the data stored in the memory if it has been judged that no error in the data stored in the memory is detected by the judging section, and executing a recovery processing if it has been judged that an error in the data stored in the memory is detected.

2. The control device according to claim 1, wherein
the judging section judges whether the error in the data held in the memory by the power from the sub power source is detected in the case that a nonvolatile memory that holds information indicating that the data used for execution of the processing is stored in the memory is abnormal.

3. The control device according to claim 1, wherein
the judging section includes
a read-out section for reading out an information data segment corresponding to a unit length of the information data to which the error detection code is added and an error detection code segment corresponding to the length of the error detection code to be added to the information data segment from the memory; and
an error detecting section for detecting an error in the information data segment on the basis of the error detection code segment.

4. The control device according to claim 2, wherein
the judging section includes
a read-out section for reading out an information data segment corresponding to a unit length of the information data to which the error detection code is added and an error detection code segment corresponding to the length of the error detection code to be added to the information data segment from the memory; and
an error detecting section for detecting an error in the information data segment on the basis of the error detection code segment.

5. The control device according to claim 1, further comprising:
a sensing section for sensing that the power from the main power source to the memory is stopped;
a first write section for writing data-is-present information indicating that the data is stored into the memory in the case that the sensing section has sensed that the power has been stopped; and
a information judging section for judging whether the data-is-present information which has been written by the first write section is stored in the memory.

6. The control device according to claim 1, further comprising:
a sensing section for sensing that the power from the main power source to the memory is stopped;
a second write section for writing abnormality factor information indicative of a factor to stop the power in the case that the sensing section senses that the power has been stopped; and
an abnormality factor judging section for judging whether the abnormality factor information which has been written by the second write section indicates a factor to induce abnormality simultaneously in an own device and the other device which operates in synchronization with the own device,
wherein the control section,
in the case that it has been judged by the abnormality factor judging section that the abnormality factor information indicates the factor to induce abnormality simultaneously in the own device and the other device, continues execution of the processing by using the data stored in the memory.

7. The control device according to claim 6, further comprising:
a deletion section for deleting the data stored in the memory in the case that it has been judged by the abnormality factor judging section that the abnormality factor information indicates a factor to induce abnormality in the other device at a time different from the time at which abnormality is induced in the own device.

8. The control device according to claim 1, further comprising:
a sensing section for sensing that the power from the main power source to the memory is stopped;
a notifying section for notifying, in the case that he sensing section senses that the power is stopped, the other device which operates in synchronization with the own device that the power has been stopped;
an acquiring section for acquiring information that the data stored in the memory is not the latest data from the other device as a response to the notification from the notifying section; and
a third information write section for writing data-is-not-the-latest information which has been acquired by the acquiring section into the memory.

9. A storage apparatus comprising:
a plurality of storage devices for storing data; and
a control device for controlling the operations of the plurality of storage devices, wherein
the control device includes
a memory for storing data with an error detection code by being supplied a power from a main power source or from a sub power source, the data being used for execution of processing;
a judging section for judging whether an error in the data held in the memory by the power from the sub power source is detected using the error detection code after the power from the main power source to the memory has been resumed; and
a processing control section for continuing execution of the processing using the data stored in the memory if it has been judged that no error in the data stored in the memory is detected by the judging section, and executing a recovery processing if it has been judged that an error in the data stored in the memory is detected.

10. The storage apparatus according to claim 9, wherein the control device further comprises:
the judging section includes
a read-out section for reading out an information data segment corresponding to a unit length of the information data to which the error detection code is added and an error detection code segment corresponding to the length of the error detection code to be added to the information data segment from the memory; and
an error detecting section for detecting an error in the information data segment on the basis of the error detection code segment.

11. The storage apparatus according to claim 9, wherein the control device further comprises:
a sensing section for sensing that the power from the main power source to the memory is stopped;
a first write section for writing data-is-present information indicating that the data is stored into the memory in the case that the sensing section has sensed that the power has been stopped; and
a information judging section for judging whether the data-is-present information which has been written by the first write section is stored in the memory.

12. The storage apparatus according to claim 9, wherein the control device further comprises:
a sensing section for sensing that the power from the main power source to the memory is stopped;
a second write section for writing abnormality factor information indicative of a factor to stop the power in the case that the sensing section senses that the power has been stopped; and
an abnormality factor judging section for judging whether the abnormality factor information which has been written by the second write section indicates a factor to induce abnormality simultaneously in an own device and the other device which operates in synchronization with the own device,
wherein the control section,
in the case that it has been judged by the abnormality factor judging section that the abnormality factor information indicates the factor to induce abnormality simultaneously in the own device and the other device, the control section continues execution of the processing by using the data stored in the memory.

13. The storage apparatus according to claim 9, wherein the control device further comprises:
a deletion section for deleting the data stored in the memory in the case that it has been judged by the abnormality factor judging section that the abnormality factor information indicates a factor to induce abnormality in the other device at a time different from the time at which abnormality is induced in the own device.

14. The storage apparatus according to claim 9, wherein the control device further comprises:
a sensing section for sensing that the power from the main power source to the memory is stopped;
a notifying section for notifying, in the case that the sensing section senses that the power is stopped, the other device which operates in synchronization with the own device that the power has been stopped;
an acquiring section for acquiring information that the data stored in the memory is not the latest data from the other device as a response to the notification from the notifying section; and
a third information write section for writing data-is-not-the-latest information which has been acquired by the acquiring section into the memory.

15. A controlling method for controlling a control device operable under a power supplied from a main power source comprising:
storing data with an error detection code into a memory by being supplied the power from the main power source or a power from a sub power source, the data being used for execution of the processing;
judging whether an error in the data held in the memory by the power from the sub power source is detected after the power from the main power source has been resumed; and
continuing execution of the processing by using the stored data if it has been judged that no error in the data stored in the memory is detected, and executing a recovery processing if it has been judged that an error in the data stored in the memory is detected.
